(19) United States
(12) Patent Application Publication
(10) Pub. No.: US 2010/0093561 A1
(43) Pub. Date: Apr. 15, 2010

(54) Methods for producing high density patterned cell arrays for biological assays

(75) Inventors: Juha Rantala, Turku (FI); Petri Saviranta, Raisio (FI); Olli Kallioniemi, Kirjala (FI)

Correspondence Address: YOUNG & THOMPSON, 209 Madison Street, Suite 500, Alexandria, VA, 22314, US

(73) Assignee: VALTION TEKNILLINEN TUTKIMUSKESKUS, Espoo (FI)

(21) Appl. No.: 12/285,629

(22) Filed: Oct. 9, 2008

(51) Int. Cl. C40B 30/06; C40B 50/14; C40B 40/02

(52) U.S. Cl. 506/10; 506/30; 506/14

(57) ABSTRACT

The present invention relates to the fields of life sciences and biological processes. Specifically, the invention relates to microarrays and live cell based screening and molecular analysis. More specifically, the present invention relates to novel methods for the screening of the effects of a test compound on cells, for molecular analysis of the cells and for producing a microarray. The present invention also relates to cell arrays and the use of arrays for molecular analysis of the cells or for the screening of agents.

### FIELD OF THE INVENTION

The present invention relates to the fields of life sciences and biological processes. Specifically, the invention relates to microarrays and live cell based screening and molecular analysis. More specifically, the present invention relates to novel methods for the screening of the effects of a test compound on cells, for molecular analysis of the cells and for producing a microarray. The present invention also relates to cell arrays and the use of said arrays for molecular analysis of the cells or for the screening of agents. Furthermore, the present invention also relates to the use of said arrays to explore effects from one cell type to the other, to screen for drug targets essential for cancer, to screen for synthetic lethal effects of test compounds and/or to compare functional response from one cell type to another.

### BACKGROUND OF THE INVENTION

Microarray technology has revolutionized research in the DNA, gene expression and protein function fields. The microarray technology suits well to large-scale, system-wide investigations, because it enables studies of many different samples simultaneously in a rapid and economical fashion, and it enables repeats of hundreds or thousands of experiments. Therefore, microarray technology applies to studies of nucleic acids, proteins as well as cells. These days, various microarrays, such as DNA, protein and most recently cell microarrays, are common tools for high-throughput studies of biological processes.

Cell microarrays are used for the identification and assessment of biological molecules, chemical compounds and their effects. Cell microarrays can complement or replace conventional cell biological studies and thus, accelerate as well as intensify for example the search of compounds with properties of interest or the determination of the significance of molecules in cellular processes. This tool for studying functional correlation of gene products or other compounds and cell types or diseases serves the purposes of all research fields.

Cell based microarrays have been developed during this decade. Ziauddin and Sabatini were able to show cultures of cells on a slide, which contained expression constructs for specific complementary DNAs (cDNAs) as well as cationic lipids and gelatin (Ziauddin J and Sabatini D, M. 2001, Nature 411, 107-110). Thereafter, cDNAs have been replaced with small interfering RNA (siRNA) and improvements of the cell array method have been achieved for example by utilizing various surface chemical processes on the array, increasing the transfection efficiency and improving the efficiency of gene silencing.

In cell microarrays, biological molecules, such as nucleic acids, or chemical compounds are introduced into the cells in specific areas of the array surface. Nucleic acids may be expressed in the cells or they may silence the function of a gene. The biological molecules or compounds may also have any other effect on the cell, such as interaction with the molecules of the cell.

siRNAs, small hairpin RNAs (shRNAs), cDNAs, or any other reagents, such as chemical compounds, as well as transfection reagents and adhesion-promoting components are printed at high density onto the surface of a glass slide or on well plates by a robotic device. The lipid-DNA/RNA transfection method is based on the deposition of lipid/nucleic acid complexes on the surface of the slide. Alternatively DNA/RNA can be coupled with other vectors including biopolymers, nanotubes and viral vectors which deliver the molecules into the cells. Living cells are added on top of the microarray as a cell suspension, and allowed to adhere. As a result, the cells that grow on top of the printed spots with siRNA/shRNA/cDNA/compounds become locally transfected. Therefore, thousands of spots of the microarrays consist of clusters of mammalian cells that either over- or under-express a specific gene product or gene products, or are under the influence of for example a molecule or other compound. In each individual spot, the cells will be influenced by a different siRNA/shRNA/cDNA/compound, and the cellular responses in each spot can be recorded and studied with appropriate imaging methods.

The array slides can be fixed and thereafter, visualized by various detection methods such as in situ hybridisation, immunofluorescence and autoradiography. It is also possible to examine cellular processes in real time by time-lapse microscopy. The effect of the siRNA/shRNA/cDNA/compounds on the cells can also be studied by observing phenotypic alterations.

Erfle H et al. (2007, Nature Protocols Vol. 2 (No. 2), pages 392-399) describe a reverse transfection on cell arrays for high content screening microscopy. According to the method of the article, mammalian cells are seeded on the array for transfection and 20 hours afterwards the cells are processed and analysed by high-content-screening microscopy. In this method, the cells are allowed to grow all over the slides for a fixed period of time, i.e. 20 hours. Review article of Stürzl M et al. (2008, Combinatorial Chemistry & High Throughput Screening Vol. 11, pages 159-172) summarizes the present knowledge related to the reversely transfected cell microarray methodology.

Indeed, most of the known cell arrays follow a protocol in which all the added cells are let to stay on top of the array during the course of the whole experiment. This allows the cells to grow as a “lawn” all over the slides, and transfection can only be seen based on pre-defined coordinates, which makes image analysis difficult (see for example Fujimoto H et al. 2006, Bioconjugate Chem. 17, 1404-1410, WO02/077264 and WO2004/061111). Recognition of transfected cells from non-transfected is also very difficult as cells tend to migrate and mix when e.g. going through mitosis. In addition, the surrounding cells from array background rapidly grow to areas where the original population of cells have died and detached from the array surface, masking the phenotype that possibly would have otherwise been seen on the spot area. These issues complicate the use and analysis of such “lawn-type” arrays and can lead to false results. The present invention makes it possible to avoid said complications.

Contrary to the “lawn-type” cell array methods, spatially separated cell seeding areas achieved by special coatings have been suggested as a potential solution to avoid cross contamination between cell clusters. For example, particular polyvinyl alcohol coatings have been used to provide a cell repelling surface on the slide and thereafter sodium hypochloride is applied as spots for cell attachment (Peterbauer T et al. 2006, Lab. Chip. Vol. 6, pages 857-863). Kato et al., on the other hand, describe a cell array method using non-adherent cells, which are attached only to spots on the slides with a biocompatible anchor for membranes (BAM) (Kato K et al. 2003, BioTechniques, Vol. 35, pages 1014-1021).

Compared to the above-mentioned, complex methods, the present invention provides a simple and inexpensive way to produce cell spot arrays without the need of special coating or surface agents. Instead the pre-sent invention takes use of special properties of cells to allow spatial patterning to form cell spot arrays.

### BRIEF DESCRIPTION OF THE INVENTION

The object of the invention is to provide novel methods and means for solving the above-mentioned problems of “lawn-type” or “special coating” cell microarrays.

The invention provides novel methods and means for ultra high throughput screening and molecular analysis and is based on a methodological step, which takes advantage of differential cell adhesion promoting properties of the array background surface and of the surface of the arrayed spots. Thus, according to the method of the invention, differential adhesion of cells to array surface between spots and to pre-defined spots, allows controlled adhesion of cells only to predefined array positions with clearly distinguished empty space in between (FIG. 1).

The present invention relates to a novel method for the screening of the effects of test compounds on cells and to a novel method for molecular analysis of cells, said methods comprising:

a) providing at least test compounds, transfection reagents and adhesion promoting components as spots on an array platform,

b) layering cells over the array and allowing them to adhere for a specifically selected time window enabling efficient adherence of the cells onto the spots, but not onto the surface area without adhesion promoting components between the spots,

c) removing unadhered and loosely bound cells,

d) adding new growth medium to the array dish for cells to grow over the time of the experiment,

e) analyzing the cells still adhered on the array.

The present invention further relates to a novel method for producing a microarray, the method comprising steps a) to c) according to above-mentioned method.

The present invention also relates to a novel cell array comprising one type of cells adhered only to the spots comprising adhesion promoting components and other types of cells on background of the array, and furthermore to a novel cell array which is produced by the method of the invention.

Furthermore, the present invention also relates to a use of the above-mentioned array for molecular analysis of the cells or for screening agents.

Still the present invention relates to uses of the arrays to explore effects, which can be direct or indirect effects, from one cell type to the other, to screen for drug targets essential for cancer, to screen for synthetic lethal effects of test compounds or to compare functional response from one cell type to another.

The method of the invention enables improvements of the image and allows an increasing variety of methods to be used for visualization. Distinct spots facilitate cell image analysis, including the use of microarray scanners. Therefore, the improvements of the present invention enhance the analysis of the cells under examination. Indeed, it is fundamental for the analysis of the cell arrays of the invention to specifically distinguish the cells or cell types of interest from the background.

Cell arrays lean on the reliability and accuracy of analysis. Cell biological assays on arrays are based on recording one or several parameters, including but not limited to cell number, cell morphology/phenotype, cellular protein markers (based on immunostaining), cell cycle/physiological status (dividing, apoptotic etc.) and cell population features on spots. The pre-sent invention makes cell population effects and concentration gradients visible allowing quantitation of new parameters, such as cell adhesion, migration and proliferation gradients outside of the spots (and many other associated phenotypes) (FIG. 2c).

The present invention allows a simple, light infrastructure demanding and inexpensive method to produce ultra dense cell arrays with variable spot sizes and array dimensions, otherwise difficult and demanding to achieve by chemical modification of array surfaces. Furthermore array patterning achieved by chemical modification of array surfaces may result to limitation of cell growth, migration and spreading in the course of assay time due to chemically restricted area available for cell growth. With the present invention, cell culture suitable materials e.g. untreated polystyrene can be used as background surface for the arrays. Here, cells can and are allowed to grow out of original spot area in the course of assay time without limitations to cell growth, migration and cell spreading. The density of cell spots with defined areas achieved with the method of the invention allows a significant increase in the throughput when compared to cell microarray method based assays of the prior art. The methods of the invention achieve a spot density far greater than with previously described cell array methods: a unique whole human genome per microplate scale.

Furthermore, the present invention enables cell co-culture testing with two cell types at a time. Co-culturing can be performed with e.g. cancer cells on the spots and stromal or epithelial cells on the background. Alternatively, various cell types can be mixed and stained for example with different fluorescent live cell dyes and assayed together on spots.

### BRIEF DESCRIPTION OF THE FIGURES

FIG. 1 shows the basic idea of the method of the invention. (1) siRNAs, cDNAs, or any other reagents are pre-mixed with transfection lipids and adhesion-promoting components and (2) spotted as microarrays on microscope slides or on multiwell plates. (3) Living cells are added on top of the microarray as a cell suspension, and (4) allowed to adhere for 1-180 minutes. The exact time of this step can be optimized according to the cell type. During the optimal time window, cells adhere efficiently onto the spots containing adhesion-promoting components, but don't significantly adhere to the area between the spots, which does not contain adhesion-promoting components. (5) Any unadhered cells are removed by gently agitating the cell suspension and then draining it off. Optionally, one or several washes can be performed to remove loosely bound cells from the areas between the spots, if necessary. (6) After the draining and optional washes, new growth medium is added to the array dish for cells to grow over the time of the experiment.

FIG. 2a shows a four channel 6 μm resolution fluorescence microarray scanned image of an immunocytochemically stained cell array of 3072 spots printed on 18 mm×54 mm area. This image illustrates the compatibility of cell spot microarrays with fluorescence microarray analysis instruments. VCaP prostate cancer cells on array are stained with SYTO16 DNA stain for DNA (blue), Phalloidin-Alexa555 for actin cytoskeleton (green), anti-Ki67 antibody-Alexa594 labeled secondary antibody for Ki76 (yellow) and anti-cleaved PARP-Alexa647 labeled secondary antibody for cleaved PARP (red).

FIG. 2b shows three channel fluorescence microscopic images with 10× magnification of PC3 prostate cancer cells on 150 μm cell array spots. This image illustrates the compatibility of cell spot microarrays with fluorescence microscopic and microscopic imaging instruments. Cells are immunocytochemically stained with anti-ITGA2 (integrin alpha 2) antibody—Alexa647 secondary antibody (red), anti-ITGB1 (integrin beta 1)—Alexa555 labeled secondary antibody (blue) and phalloidin-Alexa488 for actin cytoskeleton (green).

FIG. 2c shows three channel fluorescence microscopic images with 10× magnification of HEK-293 cells stably expressing GFP on 150 μm cell array spots. A control siRNA and CHEK-1 siRNA spot compared. This image illustrates the compatibility of cell spot microarrays with assays measuring cell population effects and concentration gradients allowing quantitation of new parameters, such as cell adhesion, migration and proliferation between spatially defined areas of spots. Here in CHEK-1 knockdown spot a proliferation gradient towards outer rim of the spot is visible. Proliferating Ki-67 positive cells are detected only on the spot edge of CHEK-1 siRNA spot. Cells were transfected for 48 h. Cells expressed GFP—Green fluorescent protein (green) and were immunocytochemically stained with anti-Ki-67 (MKI-67) antibody —Alexa647 secondary antibody (red) and DAPI for DNA (blue).

FIG. 3 illustrates a variety of cell and molecular biological assays compatible with cell spot arrays and furthermore, imaging and analysis of the cellular and cell population level parameters. Cell spot arrays can be analyzed in ultra-high-throughput manner with low resolution (2-10 μm resolution) imaging of the arrays. This represents the first level of image data acquisition from cell spot arrays in microarray level. Cell spots can also be imaged individually using traditional microscopic methods. This allows high content image data acquisition from cell spot microarrays in single cell and cell population level. This represents the second level of data acquisition from cell spot arrays in cellular level. Analysis can be done using fluorescence readouts e.g. molecular biological methods, immunocytochemical methods and measurements thereof, phase contrast imaging based measurements and image analysis for a variety of parameters extractable from these; morphology of signal positions, localization in relation to other parameters, intensity and number of detected signals. This represents the third level of data acquisition from cell spot arrays in sub-cellular and molecular level.

FIG. 4 shows example images from the different levels of data acquisition possibilities with cell spot microarrays. Measurements can be done and analyzed in array, sub array, cell spot/population, cellular, single cell and molecular level. Images are taken from a cell spot array of primary prostate stromal cells on a 21×28 spot siRNA array. Cells are immunocytochemically stained for actin cytoskeleton (blue), integrin alpha 2 (red) and integrin beta 1 (green).

FIG. 5a shows results of a cell spot microarray analysis of Qiagen Druggable genome siRNA set V3.0. Cell spot microarrays with PC-3 Prostate Cancer cells were stained for analysis of integrin beta-1 regulation with ITGB1 antibody, ITGA2 antibody and phalloidin for F-actin. Loess normalized microarray fluorescence intensity values were used for comparison of used stainings and a z-score was given for each siRNA. Data was then sorted in order of ascending ITGB1/ITGA2 ratio z-score. Staining ratios for scramble siRNA spots used as controls are shown as separate data series.

FIG. 5b shows 63× magnification microscopic images of cell spot microarray spots of PC-3 cells stained with ITGB1 antibody (blue), ITGA2 antibody (red) and phalloidin for F-actin (green). Targets found to affect the level of active state integrin beta-1 included siRNAs for GPC1 (Glypican-1 precursor) and PVR (Poliovirus receptor precursor, Nectin-like protein 5 Necl-5, CD155 antigen).

FIG. 6 shows cell spot microarrays with co-culture of two different cell lines stained with live cell fluorescent stains. VCaP cells stained with green fluorescent live cell stain were allowed to adhere to the array and the array was then overlaid with RWPE-1 cells stained with a red fluorescent live cell stain. Using different fluorescence channels of a fluorescence microarray scanner or a microscope allows specific detection of only one of the cells grown over the arrays.

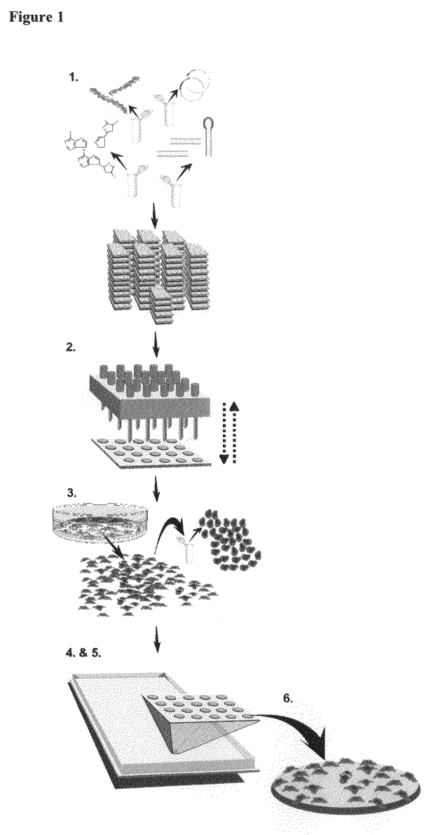

### DETAILED DESCRIPTION OF THE INVENTION

### Array Platform

As used herein, the expression “array platform” refers to a slide, a multiwell plate or an open area cell culture dish. Array surface material is either untreated or chemically modified polymer, such as polystyrene or chemically modified glass.

As used herein, the expression “spot” refers to any form of a region in the array, preferably a spot, which contains at least chemical compounds or biological molecules, such as polynucleotides, transfection reagents and adhesion proteins. The size or diameter of the spot depends on the nature of the array and can be from 100 μm to 500 μm determined by printing pinhead size. The preferable size of the spot is around 100 μm. Spots can be placed on microarrays at various densities, such as 200-1000 μm spacing, preferably 200-300 μm spacing. 100 μm spots can be provided or printed on array with as low as 300 μm spacing (1 cm² area with 1089 spots).

Spots of polynucleotides, transfection reagents and adhesion proteins can be produced on the array by conventional contact printing methods, such as exploiting a microarray printer using solid or split pins onto a smooth solid array platform. Spots can also be produced with non-contact printing methods using non-contact printing equipments or piezoelectric liquid handling pipettors. Arrays are dried and stored at room temperature before use. Background blocking is optional.

### Test Compounds, Transfection Reagents and Adhesion Promoting Components

In one preferred embodiment of the method of the invention the test compound printed on the array is selected from the group consisting of polynucleotides, oligonucleotides, polypeptides, peptides, antibodies (+scFv's, Fab's), pathogens (viruses, bacteria), nanotube vectors, lipids, sugars, and any other chemical compounds. According to the present invention said test compound can be a natural compound or can be prepared by any biological method or chemical synthesis known in the art.

In one preferred embodiment of the invention, combinations of at least two polynucleotides to different genes are used as test compounds.

In the method of the invention, different polynucleotides and different chemical compounds can be used in combination. In one preferred embodiment of the invention, at least one polynucleotide and at least one chemical compound, such as a drug, are used together as test compounds on the array.

As used herein, the expression “polynucleotides” refers to any DNA or RNA molecule or oligonucleotide with varying amount of nucleotides.

In one preferred embodiment of the method of the invention the test compound is selected from the group consisting of DNA, RNA, and any other chemical compounds.

As used herein, the expression “DNA, RNA or oligonucleotide” refers to any kind of DNAs or RNAs or oligonucleotides such as cDNA, genomic DNA, siRNA, miRNA, shRNA, piRNA, PNA, LNA or mRNA.

In one preferred embodiment of the method of the invention said test compound is cDNA, shRNA, miRNA or siRNA.

As used herein, the expression “cDNA” refers to any single-stranded complementary DNA or a double-stranded DNA copy of an original RNA transcript. In a broader sense, the term “cDNA” also refers to any expression vector containing such cDNA, which makes it possible for cells to express the cDNA-encoded genes or gene fragments.

As used herein, the expression “shRNA” refers to a small hairpin RNA or short hairpin RNA, which is a sequence of RNA that forms a hairpin-like structure. Such a shRNA can silence gene expression by RNA interference.

As used herein, the expression “miRNA” refers to a microRNAs, which are single-stranded RNA molecules regulating gene expression.

As used herein, the expression “siRNA” refers to a small or short interfering RNA, a short sequence of double stranded RNA, which is able to silence gene expression. Usually the length of siRNA varies between 21-25 base pairs.

RNA interference (RNAi) is a phenomenon of post-transcriptional gene silencing, which occurs with the help of small fragments of RNA. siRNAs mediate the degradation of their complement mRNAs. Furthermore, siRNAs can also act in other cellular processes such as shaping the chromatin structure of the genome.

Loss of functions or gain of functions of genes results from the transfection of polynucleotides to the cells. Therefore, those DNAs or RNAs, whose expression alters the normal function, morphology or gene expression pattern of the cell, can be identified. Chemical compounds or polynucleotides transfected into the cells can also have an effect on cells without being expressed. Interaction, such as hybridization or antisense activity, with cellular components can lead to the measurable changes in the cell. Antibodies binding to cell surface can be used to cause an effect on cell by e.g. blocking a receptor, ion channel/pump or other cell membrane structure from normal function.

Polynucleotides, such as cDNAs, siRNAs or shRNAs, or any other chemical compounds are spotted as microarrays at high density on the array platform. Preferably, before spotting, said polynucleotides or compounds are pre-mixed with adhesion promoting components and transfection reagents such as lipids.

As used herein, the expression “any other chemical compound” refers to chemical compounds that can exist in solid or liquid form suitable for deposition with a microarray printing robot. In context of the invention chemical compounds used for perturbation of living cells can be polypeptides, peptides, natural compounds and small molecules, chemically synthetized molecules and small molecules including known drugs and drug like molecules prepared by any biological method or chemical synthesis known in the art.

As used herein, the expression “transfection reagents” refers to lipids with either cationic, anionic or nonionic properties, immunoliposomes, viral vectors or nanostructure vectors. In a preferred embodiment of the invention transfection reagents are cationic lipids e.g. siLentFect (Bio-Rad cat. no. 170-3360).

In one preferred assay format, synthetic siRNA molecules, a lipid transfection reagent and an adhesion protein solution are mixed in cell culture growth medium. Different adhesion proteins are chosen for different cell types. Also chemicals binding to cell surface molecules, such as long fatty acid chains can be used. First diluted siRNA (0.2 μM to 4 μM) and lipid are allowed to complex in sample medium at room temperature according to the manufacturer's instructions. After this, protein mixture diluted in same medium supplemented with 10 mM to 50 mM sucrose is added to lipid and siRNA solution in 1:1 ratio. Samples are frozen for storage at −20° C.

As used herein, the expression “adhesion promoting components” refers to protein structures, peptides, carbohydrate structures, polysaccharides, proteoglycan complexes, polymers or any mixtures of these. The proteins can be but are not limited to extracellular matrix components collagen, laminin, fibronectin, keratin, heparin, elastin, osteonectin, tenascin or gelatin. The proteoglycan complexes can be but are not limited to hyaluronic acid, keratan sulfate, chondroitin sulfate, dermatan sulfate, aggrecan, heparan sulfate, decorin, lumican, nidogen or entactin. The polymer may be selected from hydrogels, biodegradable polymers, and biocompatible materials. However, the use of polymers as adhesion promoting components is optional. In a preferred embodiment of the invention, adhesion promoting components are selected from the group consisting of collagen I, collagen IV, laminin, fibronectin and entactin.

### Effects of Test Compounds on Cells

The present invention is based on a method for the screening of the effects of a test compound on cells, for molecular analysis of cells and for producing a microarray.

As used herein, the expression “the effects of a test compound on cells” refers to the effect of any biological molecule, compound, substance or any combination thereof, which alters any function or the phenotype of a cell under examination. Cellular phenotypes, functions and processes that can be examined include, but are not limited to proliferation rate/status, apoptosis rate/status, migration, adhesion, polarisation, changes in cell shape and area, expression level of individual genes and translation to proteins, localisation of proteins, protein-protein interactions metabolic activity, changes in chromatin regulation (acetylation, methylation), DNA content alterations, secretion or endocytosis of substances (proteins, chemicals, pathogens).

### Cells

As used herein, the expression “cells” refers to any structure containing material enclosed by a semipermeable membrane or a cell wall that may constitute a unicellular organism or a subunit of a multicellular organism. Individual cells may be more or less specialized or differentiated for particular functions. Examples of cells include but are not limited to prokaryotic, eukaryotic, organ or tissue cells as well as cell lines. In a preferred embodiment of the invention, cells adhering to growth surface, such as eukaryotic adherent cells, are used with the method. Preferably said adhering cells include but are not limited to cells growing as monolayers. Also cells normally growing in suspension can be used with the method, if the spots include substances capable of binding the cells, and the cells are compatible (for the purpose of the particular experiment) with sustaining their viability while bound to the spots during the time of the experiment. Substances capable of binding and capturing suspension cells include (but are not limited to) antibodies against cell-surface antigens, lectins, ligands to cell surface receptors (including natural, recombinant and synthetic ligands), and lipid membrane-binding agents.

Expressions “cell type” or “type of cell” refers to only one kind of cells or alternatively to a mixture of different kind of cells. In one preferred embodiment of the invention the cells are mixtures of cell types or cell lines.

Cells in adherent cultures are dissociated from the growth surface with chemical catalytes (defined time of treatment with trypsin, EDTA or a mixture or commercial reagents) or with mechanical cell perturbation to make a preferably single cell suspension. The suspension medium can either be conditioned culture medium, fresh complete culture medium or stripped culture medium. Living cells in suspension are then layered over the array and allowed to adhere at preferred cell culture conditions until suitable confluency on spots is achieved. Depending on the spot diameter, 20 to 400 cells are bound to one spot at full confluency.

After allowing the cells to adhere onto the array, unbound cells are removed by gently agitating the cell suspension and then draining it off. Further washes with medium or buffer can optionally be done until all or most of the unadhered or loosely bound cells left around the spots are cleared. After washes, new growth medium is added to the array dish for cells to grow over the time of the experiment. The medium and the buffer can be any conventional solutions used in the field of biotechnology. A choice of the growth medium and wash buffer depends on the cell type or cell types under examination.

As used herein, the expressions “unbound cells” or “unadhered cells” refer to cells, which have not been adhered to the spots of the array containing adhesion proteins or adhesion promoting substances. The expression also refers to the cells which may have settled by gravity on the surface area between the spots, but which have not permanently adhered due to the lack of adhesion proteins or adhesion-promoting substances at that part of the surface.

As used herein, the expression “loosely bound cells” refers to cells that have not been able to fit to spot surface area and are loosely bound to spot edges or over other cells. The expression also refers to cells, which have loosely adhered to spot free background surface of the array.

As used herein, the expressions “adhered cells” and “bound cells” refer to cells, which have been bound to the spots of the array containing adhesion proteins or after a longer period of time also onto the background of the array.

In the method of the invention, unadhered and loosely bound cells are removed before the cells adhered to the spots of the array are allowed to be transfected and grow over the time of the experiment.

In one preferred embodiment of the invention, the method is carried out with co-cultures. A first cell type, such as a cell line, is allowed to adhere to spots and after a wash another cell type, such as another cell line, is added and allowed to adhere onto background of the array. Therefore, the method of the invention comprises optionally an additional step c2) after step c), wherein another cell type, compared to the cell type allowed to adhere onto the spots, is added on the array and allowed to adhere onto background of the array.

As used herein, the expression “co-culture” refers to a simultaneous culture of different cell types or mixtures of cell types. Different cell types can adhere and can be cultured on distinct locations, such as another cell type on spots and another cell type on the background of the array. On the other hand, co-culture refers also to a mixture of different cell types, which is cultured only on spots.

### Time Window

In the method of the invention, living cells are added on top of the microarray as a cell suspension, and allowed to adhere for 1-180 minutes, preferably 1-90 minutes, more preferably 1-70 minutes, more preferably 5-60 minutes, and most preferably 5-50 minutes.

This specifically selected time window, which is a specific duration of time, is used for specific cell types to allow efficient adherence onto the spots but not onto the surface area without adhesion promoting components between the spots. The time window can vary for different cell types, and should be optimized in each case for best results. Typical time windows for some commonly used cell lines are discovered by the method of the invention and listed in Table 1. Other cell lines optimized for optimal cell adhesion time windows are listed on Table 2.

TABLE 1
TYPICAL TIME WINDOWS FOR COMMONLY USED
CELL LINES

| Cell line | Incubation time |
|---|---|
| HCT-116 | 10 min |
| HEK293 | 15 min |
| HeLa | 20 min |
| BT-474 | 25 min |
| LnCaP | 45 min |
| Primary prostate epithelial cells | 180 min |

TABLE 2
CELL LINES OPTIMIZED FOR CONTROLLED CELL ADHESION

| | |
|---|---|
| MCF-7 | Ascites cells |
| MCF-10A | KF28 |
| MDA-MB-231ATCC | KF28Tx |
| MDA-MB-231SA | KFr13 |
| MDA-MB-435 | KFr13Tx |
| MDA-MB-436 | OVCAR-3 |
| SK-BR-3 | OVCAR-4 |
| T47D | OVCAR-5 |
| ZR-75-1 | OVCAR-8 |
| MA11 | OVCAR-8/ADR |
| PM1 | 22RV1 |
| SW480 | PC-3 |
| HT29 | PWR-1E |
| Caco-2 | VCaP |
| DLD-1 | WPM4-1 |
| LS174T | P97E |
| A549 | NIH3T3 |
| UACC-257 | Primary prostate stromal cells |
| 1A9 | RWPE-1 |
| T98G | SU.86.86 |

### Detection, Image and Analysis

Analysis of any properties of the cells known in the art is included in the scope of the present invention. In addition, any detection or image method known in the art can be utilized in the method of the present invention.

The cells can be analysed or compared for example in terms of a cell number, cell morphology, cell phenotype, cellular markers or cells' physiological status on spots.

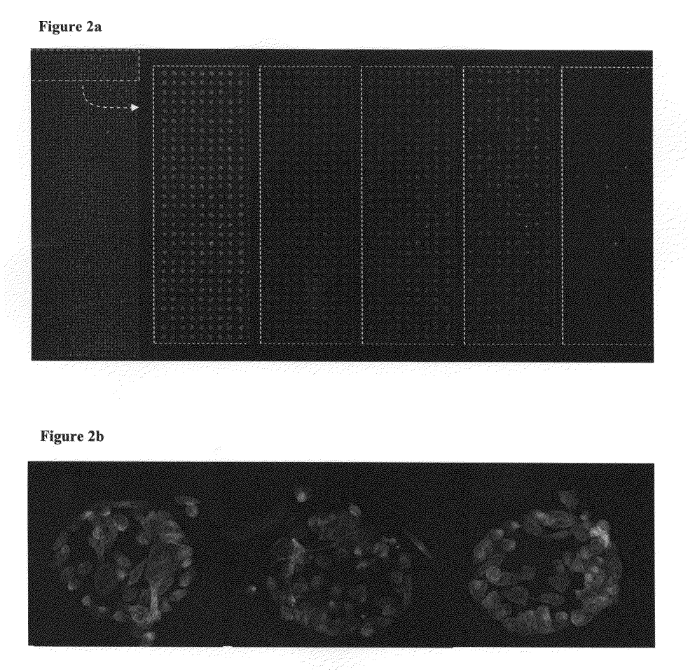

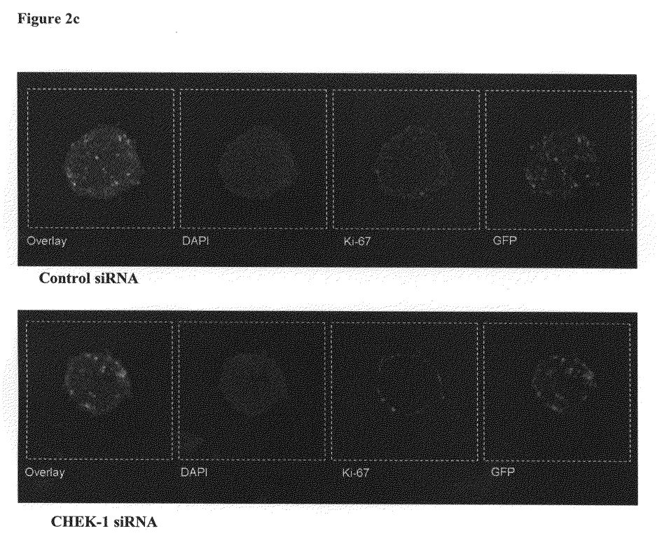

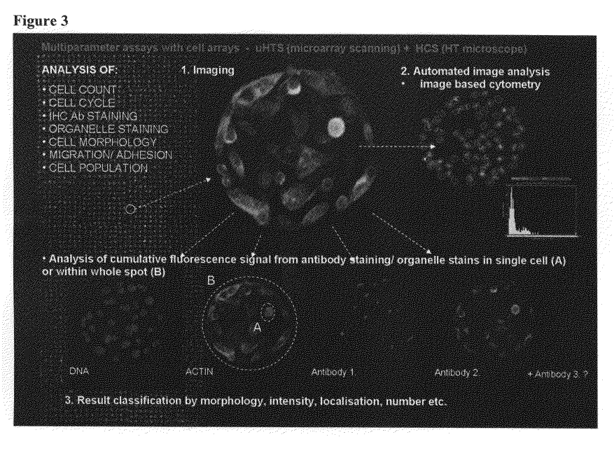

Measurements can be based on immunocytochemical staining of cell using antibodies or molecules specifically binding to cell organelles or structures (FIGS. 2a, 2b). These include DNA binding-(DAPI, Hoechst), filamentous actin binding-(phallotoxins), tubulin binding (paclitaxel) and pH sensitive fluorochromes fluorescent only in specific cellular compartments e.g. mitochondria, lysosome and ER. Analysis can focus on intensity of staining in single cell level or measured as cumulative intensity at whole spot level (FIG. 3).

Any antibody staining can be used in the cell arrays of the invention when staining is done with traditional immunostaining protocols. Possibility to use also coverslips when staining arrays dramatically reduces reagent consumption when compared to using antibody based readouts with microwell based/microplate based screening. For example staining of one cell array with 18 mm×72 mm area and 9216 spots can be done using a cover slip with 80 μl of antibody solution. For comparison staining 9216 of 384 well plate wells consumes 46080 μl of antibody solution (5 μl of solution per well). Anti-body markers for proliferating cells include such as Ki67 and PCNA, for apoptotic cells such as cleaved PARP, cleaved caspace-3 and phospho-H2Ax, for different cell cycle phases such as phospho-Histone 3 and cyclins D, -E and -B.

Fluorescent marker molecules for live/dead cells include such as FITC-VAD-FMK.

Protein interaction measurements can be performed by using Fluorescence resonance energy transfer (FRET), Fluorescence recovery after photobleaching (FRAP) or proximity ligation assay (PLA).

Fluorescence in situ hybridization (FISH) is also an exploitable method in analyzing cell arrays.

Measurements can also be done with mass spectrometry directly from arrays with each spot analyzed separately when arrays are pre-pared on mass spectrometry compatible surface e.g. coated glass or plastic conducting electricity.

Timelapse phasecontrast imaging can be used for tracking of cells, cell morphology, cell movements and cell physiology on spots and fluorescence timelapse imaging for tracking of molecules, cell structures and cell physiology in cells expressing eg. GFP-conjugated protein constructs or only GFP, CFP etc. Timelapse of cells on arrays has been tested successfully for 120 h non-stop. Measurement of phenotype occurrence may be directed for example to mitotic, apoptotic or stableproperties. Measurements of movements include for example direction, speed, length etc.

Image based cytometry can be used for analyzing array spots. DNA staining used in automated image analysis (segmentation) where stain intensity vs. nuclei area is used to distinguish cells in different cell cycle phases. Additionally antibody staining can be correlated with clustered (gated in flow cytometry terms) populations making scatter plots.

Cells from spots can also be taken to further studies using e.g. laser microdissection.

Cell population parameters can also be used as the measured readout. Spot morphology in the course of assay time can be measured with several shape describing parameters and used as assay readout. These include, but are not limited to shape features like roundness of spot, area of spot and area of empty space within the spot. Cell population features in single cell level that can be used as readout for assays include, but are not limited to number of cells migrating from the original spot area, intensity and existence of cell-cell adhesions, distribution of cellular responses spatially within the spot and multilayer growth of cell within spot.

Cell morphology features, which can be measured with phase contrast imaging, include features such as cell area, shape e.g. roundness/polarization/cell structure and structure phenotype e.g. lamellipodia shape and number.

Cell spot microarrays and scanned images of arrays are fully compatible with microarray analysis softwares as such. Spot morphology is extremely uniform in cell spot arrays and therefore, spots can be readily found by spot finding algorithms of array analysis softwares etc. (FIG. 2a).

Spots are uniform and well suitable for automated microscopic imaging and image analysis without need for software based masking of areas surrounding spots including cell to be excluded from analysis. Phenotypes, differences in staining recognized from spot to spot are easy to compare. The size of printed spots physically limits the number of cells in the beginning of assays due to same spot area where cells can adhere as a monolayer (FIGS. 2a, 2b).

### Utility

The method of the invention enables rapid and effective screening or analysis of a multitude of biological molecules or chemical compounds. Empty areas between the microarray spots enable easy and efficient detection and further analysis of the cells attached to the spots.

In preferred embodiments of the method of the invention, the array is used for exploring effects from one cell type to the other, for screening drug targets essential for cancer, for screening synthetic lethal effects of test compounds or for comparing functional response from one cell type to another.

The methods and means of the invention enable the discovery of novel cell specific markers or furthermore, diagnostic markers. In addition, discoveries of new medicaments and therapeutic methods are potentiated. Also direct as well as indirect gene profiling becomes available through novel method of the invention, which opens the way for more accurate analysis of the cells.

The present invention is illustrated by the following examples, which are not intended to be limiting in any way.

### EXAMPLE 1

### Cell Spot Microarrays for Genome Scale RNAi Analysis Using siRNA Reverse Transfection

### I. Sample Preparation

### Materials

384-Well Microarray Plates with cylindrical wells (Thermo Fisher Scientific Inc, cat. AB-1055)

### Matrigel (BD Biosciences, Basement Membrane Matrix, Growth Factor Reduced (GFR), cat. 354230)

siRNA (Qiagen Human Druggable Genome siRNA Set V3.0)
siLentFect Transfection reagent (Bio-Rad Laboratories, cat. 170-3360)

### Opti-MEM I Reduced-Serum Medium (Invitrogen, cat. 11058-021)

siRNA-matrix sample dilutions in 384 well format

Synthetic concetrated siRNA stocks were diluted with Opti-MEM to give final [siRNA]=1.67 μM*

5 μl of diluted siRNA was mixed with 0.5 μl of siLentFect transfection reagent** and incubated for 1 h at room temperature***

2 μl of Matrigel per siRNA sample was mixed with 2.5 μl of ice cold Opti-MEM and kept at +4° C.****

siRNA-lipid mixture and the diluted Matrigel were mixed together thoroughly to give final siRNA concentration of 835 nM and matrix component concentrations of 1 mg/ml laminin, 0.5 mg/ml collagen IV and 0.1 mg/ml entactin.*****

Ready mixed siRNA sample plates were stored at −20° C. between use.

* range of siRNA concentration that worked under the conditions used=0.8 μM to 4 μM.

** range of transfection reagent volume that worked under the conditions used=0.3 μl, to 1 μl.

*** range of incubation time that worked under the conditions used=15 min to 120 min.

**** range of protein matrix concentration that worked under the conditions used=10% to 25%.

***** range of individual matrix component concentrations that worked under the condition used=laminin 0.5-1.25 mg/ml, collagen IV 0.25-0.65 mg/ml and entactin 0.05-0.15 mg/ml.

### II. Microarray Procedure

### Materials

ACCELERATOR™ SOLID SPOTTING PINS, (Point Technologies S.A. Veridiam Medical. cat. PTLS200)

Nunc 4 well rectangular dish (Thermo Fisher Scientific Inc, cat. 267061) Genetix Qarray2 robotic microarrayer

### Array Printing

siRNA-matrix samples prepared in 384-well plates for arraying purpose were printed to untreated polystyrene surface using a GENETIX Qarray2 microarrayer and Point Technologies' ACCELERATOR PTLS200 solid tip pins.* With a 16 pin setup arrays of 9216 spots with 375 μm spot to spot distance in 18 mm×72 mm area were printed to Nunc 4 well rectangular dish wells. With four individual arrays in one 4 well plate the plate had 36864 samples.** A 55% relative air humidity was maintained during the arraying.*** A thorough replicated water wash step followed by ethanol and air drying was implemented between each siRNA sample to avoid accumulation of material on the surface of pins and sample carry over. After printing the plates were allowed to dry at room temperature covered from dust for 2 h to point of use.

### Storage

For storage purposes, printed array plates were kept at room temperature dry, covered from light and dust****.

* range of pin tip diameter that worked under the conditions used=100 μm to 500 μm.

** range of spot density that worked under the conditions used=100 spots/cm² to 1089 spots/cm² (1000 μm to 300 μm spot to spot spacing).

*** range of air humidity that worked under the conditions used=45% to 70%.

**** range of storage time that worked under the conditions used=2 hours to 6 months.

### III. Cell Application Procedure

### Materials

Tissue Culture hood

PC-3 Human Prostate Cancer Cells (ATCC cat. CRL-1435)

### F-12K (Gibco, cat. 21127-022)

Foetal bovine serum (Gibco, cat. 10270106)
HyQ®Tase™ (Thermo Fisher Scientific Inc, cat. SV30030.01)

### Cell Application

In a sterile cell culture laminar, 6×10⁶ actively growing PC-3 Human Prostate Cancer Cells* cultured in RPMI-1640 Cell Growth Medium, were washed once with PBS and detached from cell culture plate with HyQ®Tase™ cell detachment solution.** After 5 min incubation at +37° C., 5% CO₂ or at the point of near complete cell detachment cells were resuspended back to 16 ml of conditioned growth medium. 4 ml of cell suspension with 1.5×10⁶ cells was added carefully to any one corner of the well while avoiding direct application of cells over the printed array.*** Cells were then incubated over the arrays at +37° C., 5% CO₂ for 25 min.**** After the first incubation step medium with floating cells was removed from the well and replaced with 4 ml of fresh growth medium and incubated again for 25 min at +37° C., 5% CO₂.**** After the second incubation step all unbound cells were thoroughly washed off from the well by rinsing with PBS and finally after no loose cells were detected in the wash solution 4 ml of fresh growth medium was added into the well. Cells were allowed to reverse transfect for 48 h. *****

* range of cell number that worked under the conditions used=6×10⁶ to 1×10⁷.

** range of reagent volume that worked under the conditions used=1 ml-5 ml/10 cm petri dish.

*** range of cell suspension volume per well that worked under the conditions used=4 ml to 8 ml.

**** range of first incubation step time that worked under the conditions used=8 min to 60 min.

***** range of reverse transfection time that worked under the conditions used=24 h to 7 d.

### IV. Methods of Detection

### Materials

Tissue Culture hood

Cover Slips (75 mm×25 mm)
Tecan LS400 microarray scanner
Zeiss Axiovert 200M motorized fluorescence microscope

### Immunofluorescence

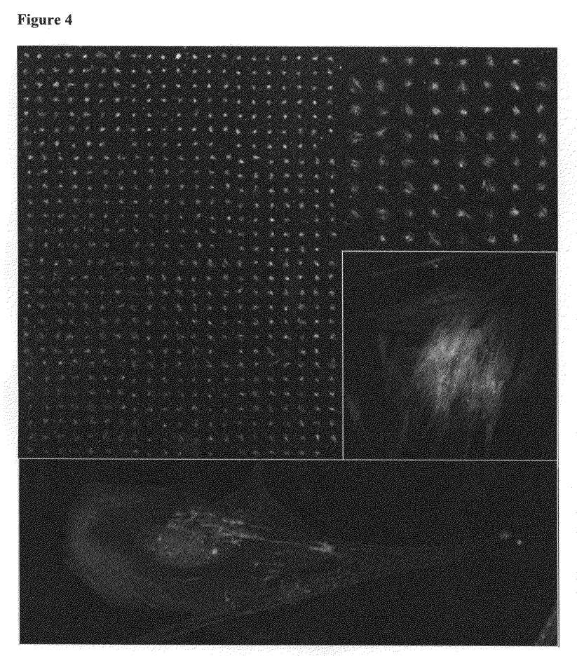

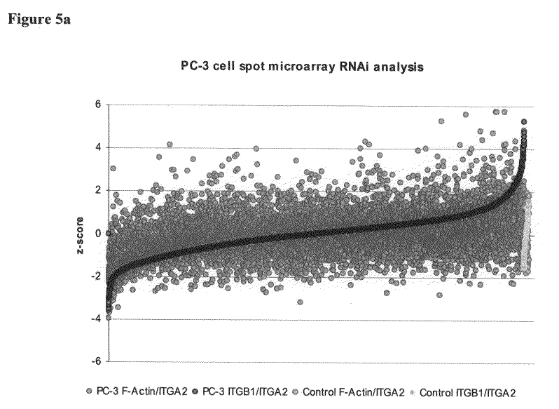

After 48 h incubation the growth medium was removed from the wells and cells were briefly rinsed with PBS and fixed with 2% paraformaldehyde, 2 mM MgCl₂, PBS for 15 min at room temperature. PFA was inactivated by rinsing the wells with 50 mM NH₄Cl₂. After fixation, the cells were permeabilized with 0.3% TRITON X-100, 10% horse serum in PBS for 15 minutes. After one rinse with 0.05% PBS-Tween 20 for 5 min and two rinses with PBS, the wells were blocked for 60 minutes with 30% horse serum in PBS, washed again with 0.05% PBS-Tween 20 for 5 min and two rinses with PBS, rinsed with water, dried and probed with two primary antibodies (12G10 for integrin beta-1, 1936 for integrin alpha-2) at 1:400 dilution for 60 minutes, washed with 0.05% PBS-Tween 20 for 5 min and two rinses with PBS, rinsed with water and dried. After primary antibody probing samples were probed with fluorescent secondary antibodies at 1:400 dilution, and fluorescently labeled phalloidin for actin cytoskeleton and a fluorescent DNA stain for 60 minutes. The wells were then thoroughly washed with 0.05% PBS-Tween 20 for 5 min, PBS and rinsed with dH₂O and air dried (FIG. 4). All stainings were done using cover slips over the cell spot arrays to reduce staining solution consumption to minimum.

### Laser Scanning

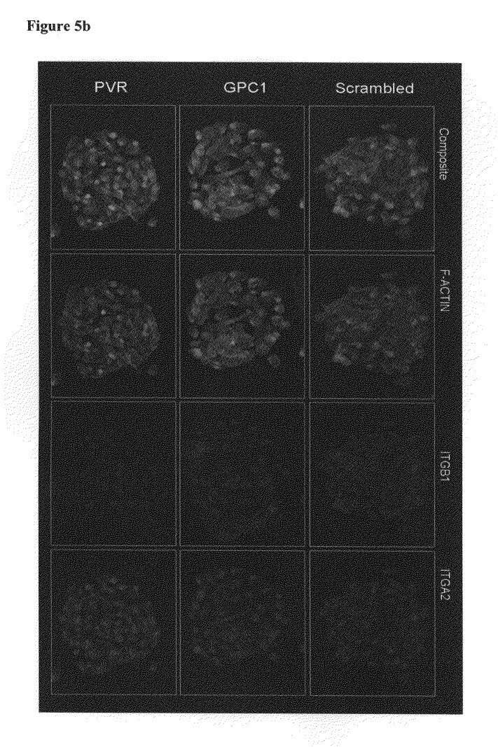

For rapid low resolution visualization and analysis of arrays plates were scanned with a four laser microarray scanner using 4 μm resolution (FIG. 4). Dry, stained arrays were analysed in parallel with four fluorescence channels. Cumulative fluorescence intensity of ITGB1 antibody staining and phalloidin F-actin staining were compared to ITGA2 antibody staining. Analysis and signal processing was done using microarray analysis software Array-Pro Analyzer 4.5 (Media Cybernetics) (FIGS. 5a-b).

### Fluorescence Microscopy

For high content analysis of cells on arrays, plates were imaged using a motorized automated fluorescence microscope Zeiss Axiovert 200M. For higher magnification imaging using oil immersion objectives (FIG. 4) and use of laser scanning microscope arrays were mounted with Mowiol and covered with a cover slip.

### Storage

After fixation, staining and analysis arrays were kept dry at room temperature covered from light (maximum of 2 years).

### Results

After scanning and microarray analysis of the cell arrays the siRNAs impacting on integrin beta-1 activation were recognized based on comparison of measured intensity of ITGB1 active epitope (12G10 Abcam) anti-body staining to measured intensity of ITGA2 antibody staining. Z-scores for ITGB1/ITGA2 staining ratio of all screened siRNAs were calculated based on cumulative fluorescence intensity measured per spot (FIG. 5a). siRNAs causing an effect with +/−2 sd (z-score +/−2) (FIG. 5a) were selected for further studies and high content analysis with a fluorescence microscopic using 63× objective (FIG. 5b). Examples of RNAi induced effects on activation of ITGB1 include silencing of genes GPC1 (Glypican-1 precursor) and PVR (Poliovirus receptor precursor, Nectin-like protein 5 Necl-5, CD155 antigen). A scramble siRNA control treatment was shown for comparison (FIG. 5b).

### EXAMPLE 2

### Co-Culture Cell Spot Microarrays for Genome Scale RNAi Analysis Using siRNA Reverse Transfection

Procedures I, II and IV have been carried out according to the corresponding procedures of Example 1.

### III. Cell Application Procedure

### Materials

Tissue Culture hood

VCaP human prostate cancer cells (ATCC, cat. CRL-2876)
RWPE-1 human prostate epithelial cells (ATCC, CRL-11609)
Foetal bovine serum (Gibco, cat. 10270106)

### K-SFM Keratinocyte Serum Free Media (Invitrogen, cat. 17005-042)

HyQ®Tase™ (Thermo Fisher Scientific Inc, cat. SV30030.01)
CellTracker™ Green CMFDA (5-chloromethylfluorescein diacetate) (Invitrogen, cat. C2925)
CellTracker™ Red CMTPX (invitrogen, cat. C34552)

### Cell Application

In a sterile cell culture laminar, 6×10⁶ actively growing VCaP Human Prostate Cancer Cells* stained with cell permeant long term fluorescent cell tracing reagent CellTracker™ Green CMFDA****** cultured in K-SFM Keratinocyte Serum Free Medium, were washed once with PBS and detached from cell culture plate with HyQ®Tase™ cell detachment solution.** After 5 min at +37° C., 5% CO₂ or at the point of near complete cell detachment cells were resuspended back to 16 ml of conditioned growth medium. 4 ml of cell suspension with 1.5×10⁶ cells was added carefully to any one corner of the wells while avoiding direct application of cells over the printed array.*** Cells were then incubated over the arrays at +37° C., 5% CO₂ for 45 min.**** After the first incubation step medium with floating cells was removed from the wells and replaced with 4 ml of fresh growth medium and incubated again for 45 min at +37(C, 5% CO₂.**** After the second incubation step all unbound cells were thoroughly washed off from the well by rinsing with PBS and finally after no loose cells were detected in the wash solution 4 ml of fresh growth medium was added into the well. After VCaP cells were attached to array spots, 6×10⁶ actively growing RWPE-1 human prostate epithelial cells* stained with cell permeant long term fluorescent cell tracing reagent CellTracker™ Red CMTPX****** cultured in K-SFM Keratinocyte Serum Free Medium, were washed once with PBS and detached from cell culture plate with HyQ®Tase™ cell detachment solution.** After 5 min at +37° C., 5% CO₂ or at the point of near complete cell detachment cells were resuspended back to 16 ml of fresh growth medium. 4 ml of cell suspension with 1.5×10⁶ cells was added carefully to any one corner of the wells while avoiding direct application of cells over the printed array where first added cells were attached.*** Cells were then incubated over the arrays at +37° C., 5% CO₂ for 90 min.**** After the first incubation step medium with floating cells was removed from the wells and replaced with 4 ml of fresh growth medium. Cells were allowed to reverse transfect for 48 h. *****

* range of cell number that worked under the conditions used=6×10⁶ to 1×10⁷.

** range of reagent volume that worked under the conditions used=1 ml-5 ml/10 cm petri dish.

*** range of cell suspension volume per well that worked under the conditions used=4 ml to 8 ml.

**** range of first incubation step time that worked under the conditions used=10 min to 120 min.

***** range of reverse transfection time that worked under the conditions used=24 h to 7 d.

****** range of reagent concentration that worked under the conditions used=1 μM to 25 μM.

### Results

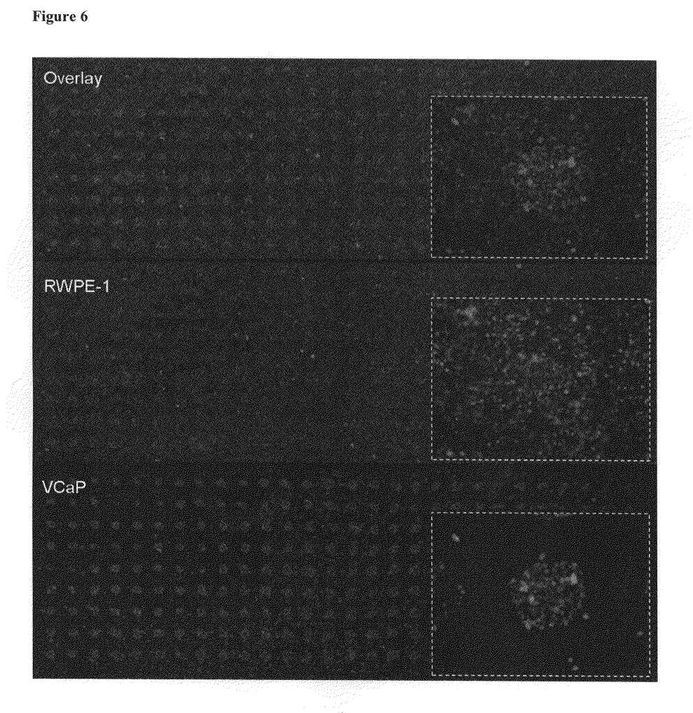

After 48 h incubation the growth medium was removed from the wells and cells were briefly rinsed with PBS and fixed with 2% paraformaldehyde, mM MgCl₂, PBS for 15 min at room temperature. PFA was inactivated by rinsing the wells with 50 mM NH₄Cl₂. After fixation, the cells were washed with PBS, rinsed with water and dried. The dry array was scanned with a microarray scanner using a green and a red fluorescent channel to separately detect the two cell lines differently labeled with fluorescent stains. Using different fluorescence channels it was possible to accurately distinguish the cell lines co-cultured on the array (FIG. 6).

1. A method for the screening of the effects of a test compound on cells, said method comprising:
a) providing at least test compounds, transfection reagents and adhesion promoting components as spots on an array platform,
b) layering cells over the array and allowing them to adhere for a specifically selected time window enabling efficient adherence of the cells onto the spots, but not onto the surface area without adhesion promoting components between the spots,
c) removing unadhered and loosely bound cells,
d) adding new growth medium to the array dish for cells to grow over the time of the experiment,
e) analyzing the cells still adhered on the array.

2. A method for molecular analysis of cells, said method comprising:
a) providing at least test compounds, transfection reagents and adhesion promoting components as spots on an array platform,
b) layering cells over the array and allowing them to adhere for a specifically selected time window enabling efficient adherence of the cells onto the spots, but not onto the surface area without adhesion promoting components between the spots,
c) removing unadhered and loosely bound cells,
d) adding new growth medium to the array dish for cells to grow over the time of the experiment,
e) analyzing the cells still adhered on the array.

3. A method for producing a microarray, said method comprising:
a) providing at least test compounds, transfection reagents and adhesion promoting components as spots on an array platform,
b) layering cells over the array and allowing them to adhere for a time window enabling efficient adherence of the cells onto the spots, but not onto the surface area without adhesion promoting components between the spots,
c) removing unadhered and loosely bound cells.

4. A method according to claim 1, wherein the method is carried out with co-cultures.

5. A method according to claim 1, wherein the method optionally comprises an additional step c2) after step c), wherein another cell type is allowed to adhere onto background of the array.

6. A method according to claim 1, wherein the cells are mixtures of cell types or cell lines.

7. A method according to claim 1, wherein said test compound is selected from the group consisting of DNA, RNA, and any other chemical compounds.

8. A method according to claim 7, wherein said test compound is cDNA, shRNA, miRNA or siRNA.

9. A method according to claim 3, wherein the array is used for exploring effects from one cell type to the other.

10. A method according to claim 3, wherein the array is used for screening drug targets essential for cancer.

11. A method according to claim 3, wherein the array is used for screening synthetic lethal effects of test compounds.

12. A method according to claim 3, wherein the array is used for comparing functional response from one cell type to another.

13. A cell array comprising one type of cells adhered only to the spots comprising adhesion promoting components and other types of cells on background of the array.

14. A cell array comprising one type of cells adhered only to the spots comprising adhesion promoting components and other types of cells on background of the array, which is produced by the method of claim 3.

15. A cell array, which is produced by the method of claim 3.

16. Use of the array of claim 13 for molecular analysis of the cells or for screening agents.

17. Use of the array of claim 13 to explore effects from one cell type to the other.

18. Use of the array of claim 13 to screen for drug targets essential for cancer.

19. Use of the array of claim 13 to screen for synthetic lethal effects of test compounds.

20. Use of the array of claim 13 to compare functional response from one cell type to another.
